(19) United States
(12) Patent Application Publication
(10) Pub. No.: US 2007/0109788 A1
(43) Pub. Date: May 17, 2007

(54) BACKLIGHT MODULE

(76) Inventor: Bor-Jyh Pan, Hsinchu (TW)

Correspondence Address: NORTH AMERICA INTELLECTUAL PROPERTY CORPORATION, P.O. BOX 506, MERRIFIELD, VA, 22116, US

(21) Appl. No.: 11/534,678

(22) Filed: Sep. 25, 2006

(30) Foreign Application Priority Data
Nov. 11, 2005 (TW) 094139839

(51) Int. Cl. F21V 29/00

(52) U.S. Cl. 362/294

(57) ABSTRACT

A backlight module includes a heat-dissipating element, at least one light-emitting element disposed on the heat-dissipating element, and a reflective plate disposed on the heat-dissipating element. The reflective plate includes at least one opening for the light-emitting element to pass through. The backlight module further includes a circuit board disposed between the heat-dissipating element and the reflective plate for driving the light-emitting element. The circuit board includes at least one opening for the light-emitting element to pass through, and at least one electrical connection part for electrically connecting the circuit board and the light-emitting element.

### BACKGROUND OF THE INVENTION

1. Field of the Invention

The present invention relates to a backlight module, and more particularly, to a backlight module with a LED as a light-emitting element.

2. Description of the Prior Art

Please refer to FIG. 1. FIG. 1 is a diagram of a conventional backlight module 100. The backlight module 100 includes a backing plate 110, a reflective plate 120, a plurality of LEDs 130, a LED driver 1306, and a plurality of circuit boards 140 for supporting the LEDs 130.

The backing plate 110 is usually made of metal material or other material with a good thermal conductivity. The lateral sides of the backing plate 110 are protruding upwardly to form a box for supporting the circuit boards 140 and for dissipating heat generated by the LEDs 130. The reflective plate 120 is disposed between the backing plate 110 and the circuit boards 140. The reflective plate 120 includes a plurality of openings for the LEDs 130 to pass through. The reflective plate 120 reflects light emitted from the LEDs 130 in order to increase the luminance and the uniformity of brightness of the backlight module 100. Please refer to FIG. 2. FIG. 2 is a sectional view of the conventional backlight module 100. Each LED 130 includes a light-emitting chip 1301 for being driven so that the LED 130 emits the light, a heat-conducting structure 1302 for conducting heat generated by the LED 130, and at least one pin 1304. Each circuit board 140 is a printed circuit board (PCB). Each circuit board 140 includes a substrate 1402, a copper line layer 1404, and a solder resist layer 1406. The pin 1304 of the LED 130 is electrically connected to the copper line layer 1404 by soldering. The circuit board 140 is electrically connected to the LED driver 1306 for driving the LED 130 to emit light.

Generally, the operation temperature of the LED 130 influences the light-emitting efficiency and stability of the LED 130. When the operation temperature of the LED 130 increases, the light-emitting efficiency and stability of the LED 130 decrease. However, the substrate 1402 of the backlight module 100 is a fiber glass substrate (FR4) with a poor thermal conductivity. It causes that the heat generated by the LED 130 is not dissipated from the backing plate 110 but is gathered at the heat-conducting structure 1302. The operation temperature of the LED 130 increases so that the light-emitting efficiency and stability of the LED 130 decrease and the voltage resistivity of the substrate 1402 decreases.

Please refer to FIG. 3. FIG. 3 is a sectional view of another conventional backlight module 200. The backlight module 200 includes a backing plate 210, a reflective plate 220, a plurality of LEDs 230, and a plurality of metal core printed circuit boards (MCPCB) 240 for supporting the LEDs 230. Each LED 230 includes a heat-conducting structure 2302 for conducting heat generated by the LED 230, and at least one pin 2304. Each metal core printed circuit board 240 includes a metal substrate 2402, a copper line layer 2404, a solder resist layer 2406, and an insulating thermal membrane 2408. The metal core printed circuit board 240 with a good voltage resistivity and thermal conductivity to dissipate the heat generated by the LED 230 effectively. However the metal core printed circuit board 240 is much more expensive than the printed circuit board made of fiber glass substrate. In addition, the insulation of the metal core printed circuit board 240 is provided by the insulating thermal membrane 2408 with a thickness about 75 to 200 μm, and the insulating thermal membrane 2408 peels off easily so as to affect the electrical contact when manufacturing the metal core printed circuit board 240 improperly.

### SUMMARY OF THE INVENTION

It is therefore a primary objective of the claimed invention to provide a backlight module for solving the above-mentioned problem.

According to the claimed invention, a backlight module includes a heat-dissipating element such as a backing plate, at least one light-emitting element disposed on the heat-dissipating element, and a reflective plate disposed on the heat-dissipating element. The reflective plate includes at least one opening for the light-emitting element to pass through. The backlight module further includes a circuit board disposed between the heat-dissipating element and the reflective plate for driving the light-emitting element to pass through. circuit board includes at least one opening for the light-emitting element to pass through, and at least one electrical connection part for electrically connecting the circuit board and the light-emitting element.

According to the claimed invention, a backlight module includes a heat-dissipating pad, at least one light-emitting element disposed on the heat-dissipating pad, and a backing plate disposed on the heat-dissipating pad. The backing plate includes at least one opening for the light-emitting element to pass through. The backlight module further includes a reflective plate disposed on the heat-dissipating pad. The reflective plate includes at least one opening for the light-emitting element to pass through. The backlight module further includes a circuit board disposed between the heat-dissipating pad and the backing plate for driving the light-emitting element. The circuit board includes at least one opening for the light-emitting element to pass through, and at least one electrical connection part for electrically connecting the circuit board and the light-emitting element.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a conventional backlight module.

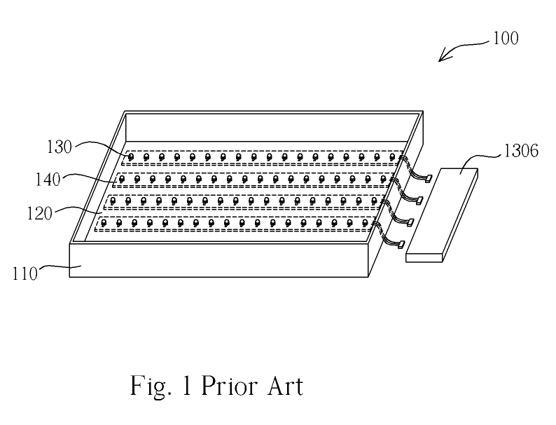

FIG. 2 is a sectional view of the backlight module shown in FIG. 1.

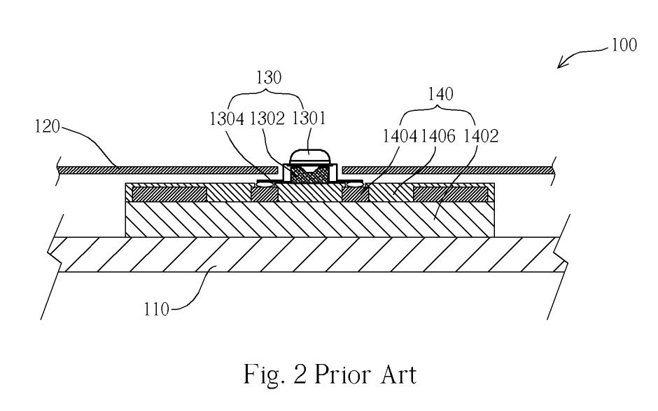

FIG. 3 is a sectional view of another conventional backlight module.

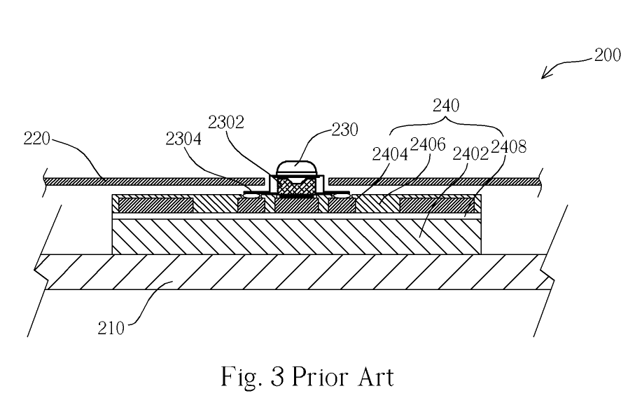

FIG. 4 is a sectional view of a backlight module according to a first embodiment of the present invention.

FIG. 5 is an exploded diagram of the backlight module shown in FIG. 4.

FIG. 6 is a sectional view of a backlight module according to a second embodiment of the present invention.

FIG. 7 is a sectional view of a backlight module according to a third embodiment of the present invention.

FIG. 8 is a sectional view of a backlight module according to a fourth embodiment of the present invention.

FIG. 9 is a sectional view of a backlight module according to a fifth embodiment of the present invention.

FIG. 10 is a sectional view of a backlight module according to a sixth embodiment of the present invention.

FIG. 11 is a sectional view of a backlight module according to a seventh embodiment of the present invention.

FIG. 12 is a sectional view of a backlight module according to an eighth embodiment of the present invention.

### DETAILED DESCRIPTION

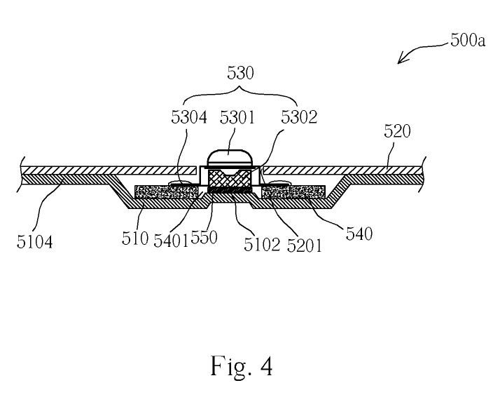

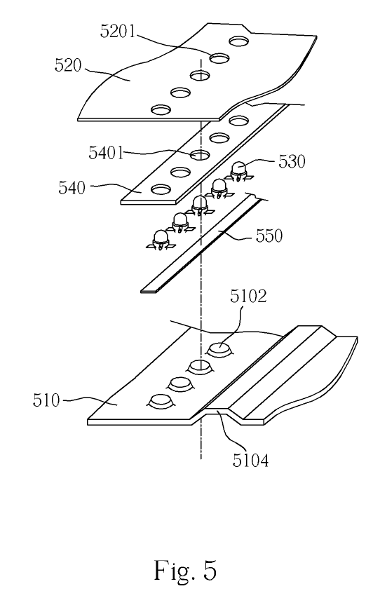

Please refer to FIG. 4 and FIG. 5. FIG. 4 is a sectional view of a backlight module 500a according to a first embodiment of the present invention. FIG. 5 is an exploded diagram of the backlight module 500a shown in FIG. 4. The backlight module 500a includes a backing plate 510, a reflective plate 520, a plurality of LEDs 530, and a plurality of circuit boards 540. The backing plate 510 includes at least one first protruding part 5102 and at least one second protruding part 5104. The backing plate 510 is a heat-dissipating element and usually made of metal material or other material with a good thermal conductivity. The first protruding part 5102 supports the LED 530, and the second protruding part 5104 supports the reflective plate 520. The reflective plate 520 is made of metal material in order to reflect light emitted from the LED 530 so as to increase the luminance and the uniformity of the light emitted from the LED 530. The reflective plate 520 includes an opening 5201 for the LED 530 to pass through. The LED 530 is a light-emitting element. The LED 530 includes a light-emitting chip 5301, a heat-conducting structure 5302, and at least one pin 5304. The heat-conducting structure 5302 is disposed on the bottom of the light-emitting chip 5301 and connected to the first protruding part 5102 of the backing plate 510 by heat-conducting glue 550 or soldering. The heat generated by the light-emitting chip 5301 is conducted to the heat-conducting structure 5302 and the backing plate 510 and dissipated out from the backing plate 510. The circuit board 540 is disposed on a surface of the backing plate 510 facing the reflective plate 520 and disposed between the heat-dissipating element and the reflective plate 520. The circuit board 540 includes at least one opening 5401 for the first protruding part 5102 of the backing plate 510 and the LED 530 to pass through. The pin 5304 of the LED 530 is electrically connected to a copper line layer of the circuit board 540 facing the reflective plate 520 by soldering. A gap is located between the pin 5304 and the reflective plate 520 so as to prevent the poor electrical contact due to the connection between the pin 5304 or solder joint thereon and the reflective plate 520 made of metal material.

The heat-conducting structure 5302 contacts with the backing plate 510 capable of conducting and dissipating heat effectively via the opening 5401 of the circuit board 540 so as to separate the heat-dissipating path of the LED 530 from the electrical path of driving the LED 530. That is, when a LED driver (not shown in figures) electrically connected to the circuit board 540 drives the light-emitting chip 5301 to emit the light, the heat generated by the LED 530 is conducted to the backing plate 510 from the heat-conducting structure 5302 and dissipated from the backing plate 510 instead of blocking by the circuit board 540 so as to increase the heat-dissipating efficiency of the LED 530. In addition, the circuit board 540 is affected by less heat so as to increase the voltage resistivity of the circuit board 540. The heat is not conducted via the circuit board 540, and there is no need to utilize the expensive metal core printed circuit board with a good thermal conductivity so as to reduce the cost of the backlight module 500a.

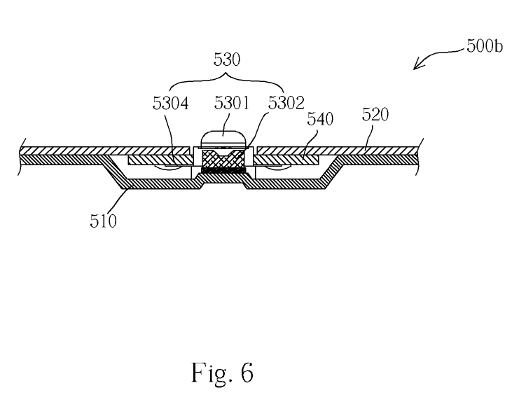

Please refer to FIG. 6. FIG. 6 is a sectional view of a backlight module 500b according to a second embodiment of the present invention. The difference between the first embodiment and the second embodiment is that the circuit 540 of the backlight module 500b is disposed on a surface of the reflective plate 520 facing the backing plate 510 and the pin 5304 of the LED 530 is electrically connected to a surface of the circuit board 540 facing the backing plate 510. A gap is located between the pin 5304 of the LED 530 and the backing plate 510 so as to prevent the poor electrical contact due to the connection between the pin 5304 or solder joint thereon and the backing plate 510 made of metal material.

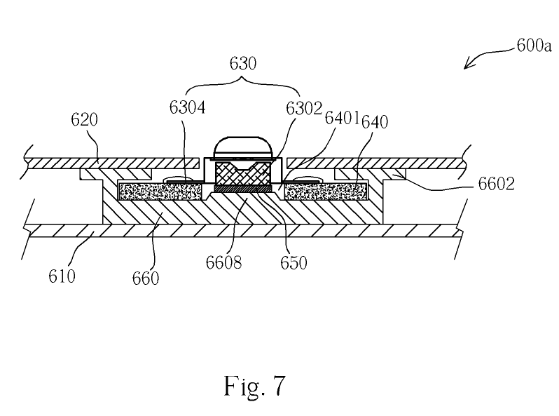

Please refer to FIG. 7. FIG. 7 is a sectional view of a backlight module 600a according to a third embodiment of the present invention. The structure of the backlight module 600a of the third embodiment is similar to the structure of the backlight module 500a according to the first embodiment of the present invention. The difference between the first embodiment and the third embodiment is described as follow. The backlight module 600a includes a backing plate 610 made of material with a good thermal conductivity, such as metal material. A heat-dissipating pad 660 is disposed on the backing plate 610. The heat-dissipating pad 660 and the backing plate 610 are formed a heat-dissipating element. The heat-dissipating pad 660 includes two support parts 6602 on two lateral sides and a protruding part 6608 in the center thereof. The support parts 6602 support a reflective plate 620. A LED 630 is disposed on the protruding part 6608. A heat-conducting structure 6302 disposed on the bottom of the LED 630 is connected to the protruding part 6608 of the heat-dissipating pad 660 by heat-conducting glue 650. A circuit board 640 is disposed on a surface of the heat-dissipating pad 660 facing the reflective plate 620. The circuit board 640 includes at least one opening 6401 for the protruding part 6608 of the heat-dissipating pad 660 and the LED 630 thereon to pass through. A pin 6304 of the LED 630 is electrically connected to a copper line layer of the circuit board 640 facing the reflective plate 620 by soldering. A gap is located between the pin 6304 and the reflective plate 620 so as to prevent the poor electrical contact due to the connection between the pin 6304 or solder joint thereon and the reflective plate 620 made of metal material. The heat-dissipating pad 660 according to the third embodiment of the present invention replaces the first protruding part 5102 and the second protruding part 5104 of the reflective plate 510 according to the first embodiment of the present invention so as to simplify the structure of the reflective plate 61 0. The heat-dissipating path of the LED 630 and the electrical path of driving the LED 630 are separated so as to increase the heat-dissipating efficiency of the LED 630. In addition, the circuit board 640 is affected by less heat so as to increase the voltage resistivity of the circuit board 640.

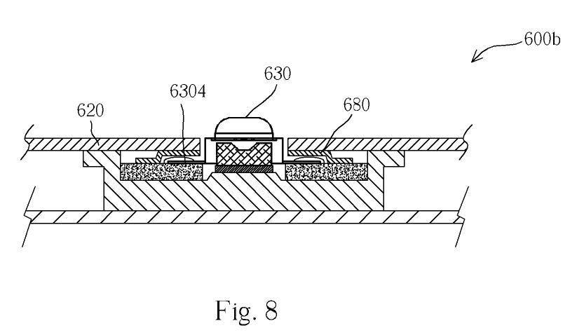

Please refer to FIG. 8. FIG. 8 is a sectional view of a backlight module 600b according to a fourth embodiment of the present invention. The structure of the backlight module 600b according to the fourth embodiment is similar to the structure of the backlight module 600a according to the third embodiment of the present invention. The difference between the fourth embodiment and the third embodiment is that the backlight module 600b further includes an insulation tape 680 attached to the pin 6304 of the LED 630 so as to prevent the poor electrical contact due to the connection between the pin 6304 or solder joint thereon and the reflective plate 620 made of metal material.

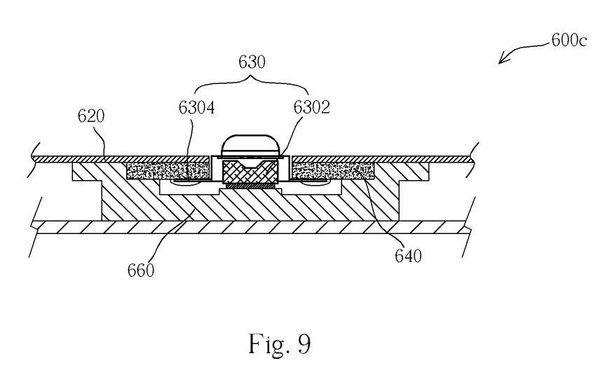

Please refer to FIG. 9. FIG. 9 is a sectional view of a backlight module 600c according to a fifth embodiment of the present invention. The structure of the backlight module 600c according to the fifth embodiment is similar to the structure of the backlight module 600a according to the third embodiment. The difference between the fifth embodiment and the third embodiment is that the circuit board 640 is disposed on a surface of the reflective plate 620 facing the heat-dissipating pad 660. The pin 6304 of the LED 630 is electrically connected to a surface of the circuit board 640 facing the heat-dissipating pad 660. A gap is located between the pin 6304 and the heat-dissipating pad 660 so as to prevent the poor electrical contact due to the connection between the pin 6304 or solder joint thereon and the heat-dissipating pad 660 made of metal material.

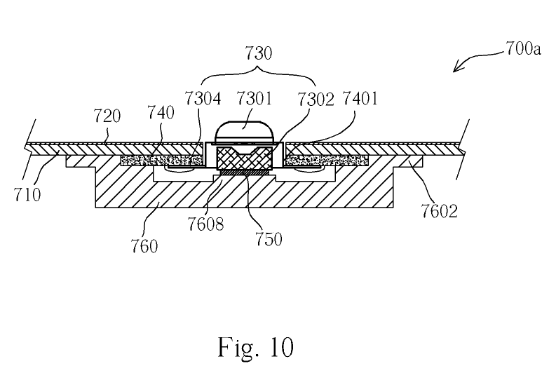

Please refer to FIG. 10. FIG. 10 is a sectional view of a backlight module 700a according to a sixth embodiment of the present invention. The backlight module 700a includes a backing plate 710, a reflective plate 720, a plurality of LEDs 730, a plurality of circuit boards 740, and a heat-dissipating pad 760. The backing plate 710 is made of metal material with a good thermal conductivity. The reflective plate 720 is disposed on the backing plate 710. Both of the reflective plate 720 and the backing plate 710 include at least one opening for the LED 730 to pass through. The heat-dissipating pad 760 is disposed under the backing plate 710. The heat-dissipating pad 760 includes two support parts 7602 on two lateral sides and a protruding part 7608 in the center thereof. The support parts 7602 support the backing plate 710. The heat-dissipating pad 760 further includes a thermal fin (not shown in FIG. 10). The LED 730 is a light-emitting element. The LED 730 includes a light-emitting chip 7301, a heat-conducting structure 7302, and at least one pin 7304. The heat-conducting structure 7302 is connected to the protruding part 7608 of the heat-dissipating pad 760 by heat-conducting glue 750. The heat generated by the LED 730 is conducted to the heat-conducting structure 7302 and the heat-dissipating pad 760 and dissipated out from the heat-dissipating pad 760. The circuit board 740 is disposed on a surface of the reflective plate 720 facing the heat-dissipating pad 760 and disposed between the heat-dissipating pad 760 and the backing plate 720. The circuit board 740 includes at least one opening 7401 for the protruding part 7608 of the heat-dissipating pad 760 and the LED 730 thereon to pass through. The pin 7304 of the LED 730 is electrically connected to a copper line layer of the circuit board 740 facing the heat-dissipating pad 760 by soldering. A gap is located between the pin 7304 and the heat-dissipating pad 760 so as to prevent the poor electrical contact due to the connection between the pin 7304 or solder joint thereon and the heat-dissipating pad 760 made of metal material. When a LED driver (not shown in FIG. 10) electrically connected to the circuit board 740 drives the light-emitting chip 7301 to emit light, the heat generated by the LED 730 is conducted to the heat-dissipating pad 760 via the heat-conducting structure 7302 so as to dissipate heat effectively. The heat-dissipating path of the LED 730 and the electrical path of driving the LED 730 are separated so as to increase the heat-dissipating efficiency of the LED 730. In addition, the circuit board 740 is affected by less heat so as to increase the voltage resistivity of the circuit board 740.

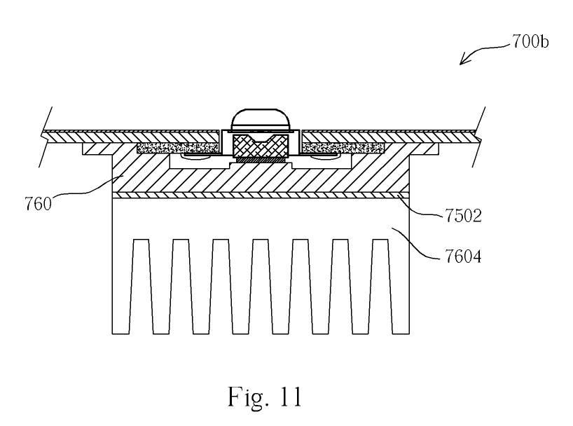

Please refer to FIG. 11. FIG. 11 is a sectional view of a backlight module 700b according to a seventh embodiment of the present invention. The structure of the backlight module 700b according to the seventh embodiment is similar to the structure of the backlight module 700a according to the sixth embodiment of the present invention. The difference between the seventh embodiment and the sixth embodiment is that the backlight module 700b further includes a thermal pad 7604. The thermal pad 7604 includes a plurality of thermal fins. The thermal pad 7604 is attached to the heat-dissipating pad 760 by heat-conducting glue 7502 or the thermal pad 7604 is formed with the heat-dissipating pad 760 integrally so as to increase the heat-dissipating efficiency further.

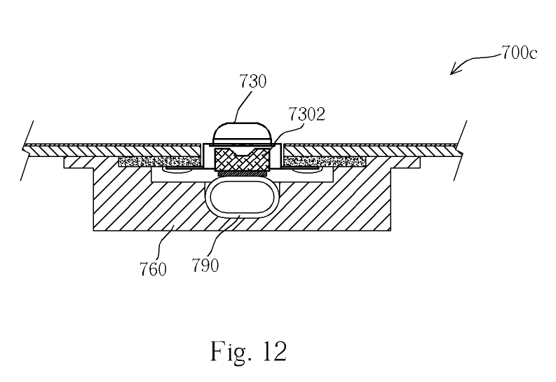

Please refer to FIG. 12. FIG. 12 is a sectional view of a backlight module 700c according to an eighth embodiment of the present invention. The structure of the backlight module 700c according to the eighth embodiment is similar to the structure of the backlight module 700a according to the sixth embodiment of the present invention. The difference between the eighth embodiment and the sixth embodiment is that the backlight module 700c further includes a heat pipe 790. The heat pipe 790 is installed inside the heat-dissipating pad 760 and connected to the heat-conducting structure 7302 of the LED 730 so as to increase the heat-dissipating efficiency and temperature uniformity of the LED 730 further.

In contrast with the conventional backlight module, the present invention separates the heat-dissipating path of the LED and the electrical path of driving the LED so as to increase the heat-dissipating efficiency of the LED. In addition, the circuit board is affected by less heat so as to increase the voltage resistivity of the circuit board. Because the heat is not conducted via the circuit board, there is no need to utilize the expensive metal core printed circuit board with a good thermal conductivity so as to reduce the cost of the backlight module.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A backlight module comprising:
a heat-dissipating element;
at least one light-emitting element disposed on the heat-dissipating element;
a reflective plate disposed on the heat-dissipating element, the reflective plate comprising at least one opening for the light-emitting element to pass through; and
a circuit board disposed between the heat-dissipating element and the reflective plate for driving the light-emitting element, the circuit board comprising at least one opening for the light-emitting element to pass through, and at least one electrical connection part for electrically connecting the circuit board and the light-emitting element.

2. The backlight module of claim 1 wherein the heat-dissipating element comprises a backing plate.

3. The backlight module of claim 2 wherein the backing plate comprises:
at least one first protruding part contacting with the light-emitting element; and
at least one second protruding part contacting with the reflective plate.

4. The backlight module of claim 1 wherein the heat-dissipating element comprises:
a backing plate; and
a heat-dissipating pad disposed on a surface of the backing plate facing the reflective plate and contacting with the light-emitting element, the heat-dissipating pad comprising two support parts on two lateral sides for contacting with the reflective plate.

5. The backlight module of claim 1 further comprising an insulator disposed on the electrical connection part.

6. The backlight module of claim 1 wherein the light-emitting element is a light-emitting diode (LED).

7. The backlight module of claim 6 wherein the light-emitting element comprises:
a light-emitting chip;
a heat-conducting structure connected to a bottom of the light-emitting chip and contacting with the heat-dissipating element directly; and
at least one pin.

8. The backlight module of claim 1 wherein a gap is located between the electrical connection part and the reflective plate.

9. The backlight module of claim 1 wherein a gap is located between the electrical connection part and the heat-dissipating element.

10. A backlight module comprising:
a heat-dissipating pad;
at least one light-emitting element disposed on the heat-dissipating pad;
a backing plate disposed on the heat-dissipating pad, the backing plate comprising at least one opening for the light-emitting element to pass through;
a reflective plate disposed on the heat-dissipating pad, the reflective plate comprising at least one opening for the light-emitting element to pass through; and
a circuit board disposed between the heat-dissipating pad and the backing plate for driving the light-emitting element, the circuit board comprising at least one opening for the light-emitting element to pass through, and at least one electrical connection part for electrically connecting the circuit board and the light-emitting element.

11. The backlight module of claim 10 wherein a thermal fin is disposed on a surface of the heat-dissipating pad opposite to the backing plate.

12. The backlight module of claim 10 wherein a heat pipe is installed inside the heat-dissipating pad, the heat pipe contacting with the light-emitting element.

13. The backlight module of claim 10 wherein the light-emitting element comprises:
a light-emitting chip;
a heat-conducting structure connected to a bottom of the light-emitting chip and contacting with the heat-dissipating pad directly; and at least one pin.
